(19) United States
(12) Patent Application Publication
(10) Pub. No.: US 2026/0122402 A1
(43) Pub. Date: Apr. 30, 2026

(54) WEARABLE ELECTRONIC DEVICE INCLUDING COUPLING MEMBER

(71) Applicant: SAMSUNG ELECTRONICS CO., LTD., Suwon-si (KR)

(72) Inventors: Byeongmin LEE, Suwon-si (KR); Kiyean KIM, Suwon-si (KR); Juhee CHANG, Suwon-si (KR); Sungjin KIM, Suwon-si (KR); Kiwook HAN, Suwon-si (KR)

(73) Assignee: SAMSUNG ELECTRONICS CO., LTD., Suwon-si (KR)

(21) Appl. No.: 19/434,717

(22) Filed: Dec. 29, 2025

Related U.S. Application Data
(63) Continuation of application No. PCT/KR2024/007318, filed on May 29, 2024.

(30) Foreign Application Priority Data
Jun. 29, 2023 (KR) 10-2023-0084445
Jul. 13, 2023 (KR) 10-2023-0090900
Nov. 6, 2023 (KR) 10-2023-0152057

(51) Int. Cl. H04R 1/10; H04R 1/02

(52) U.S. Cl. CPC H04R 1/1058; H04R 1/023; H04R 1/1016; H04R 1/1083; H04R 2420/07; H04R 2460/01

(57) ABSTRACT

A wearable electronic device may include: a housing including a space; a port that at least partially protrudes outward from the housing; an eartip including an opening, the eartip connected to the port; a speaker inside the housing and configured to output sound toward the opening of the eartip; and at least one coupling member connecting the eartip and the port, wherein the eartip includes at least one recess into which at least a portion of the at least one coupling member is inserted.

### CROSS-REFERENCE TO RELATED APPLICATIONS

This application is a bypass continuation of International Patent Application No. PCT/KR2024/007318, filed on May 29, 2024, which claims priority to Korean Patent Application No. 10-2023-0084445, filed in the Korean Intellectual Property Office on Jun. 29, 2023, Korean Patent Application No. 10-2023-0090900, filed in the Korean Intellectual Property Office on Jul. 13, 2023, and Korean Patent Application No. 10-2023-0152057, filed in the Korean Intellectual Property Office on Nov. 6, 2023, the disclosures of which are herein incorporated by reference in their entireties.

### BACKGROUND

### 1. Field

Some embodiments of the present disclosure relate to a wearable electronic device and, more particularly, to a wearable electronic device that includes a coupling member.

### 2. Description of Related Art

With the advancement of electronic technology, various types of wearable electronic devices are required to be miniaturized and to be equipped with diverse functions. In order to meet these requirements, various electronic components are mounted on a printed circuit board (PCB).

One or more components related acoustic effects may be mounted on a printed circuit board of a wearable electronic device. The sound effect-related components may include, for example, a speaker and a microphone, and these components may be mounted within the housing of the wearable electronic device with various shapes and arrangements corresponding to the exterior design of the wearable electronic device that is designed in various ways.

The wearable electronic device equipped with the speaker and the microphone may include, for example, an in-ear earphone (or an earset, a headphone, or a headset) or a hearing aid. The wearable electronic device may be worn near a user's ear and may be manufactured in a compact size for this purpose.

The above-described information may be provided as related art for the purpose of helping to understand the present disclosure. No claim or determination is made regarding whether any of the foregoing may be applied as prior art with respect to the present disclosure.

### SUMMARY

According to an embodiment of the present disclosure, a wearable electronic device may include: a housing including a space; a port that at least partially protrudes outward from the housing; an eartip including an opening, the eartip connected to the port; a speaker inside the housing and configured to output sound toward the opening of the eartip; and at least one coupling member connecting the eartip and the port, wherein the eartip includes at least one recess into which at least a portion of the at least one coupling member is inserted.

According to an embodiment of the present disclosure, a wearable electronic device may include: a housing including a space formed; a port protruding at least partially outward from the housing; an eartip connected to the port and including an opening; a speaker inside the housing and configured to output sound toward the opening of the eartip; a plurality of coupling members connecting the eartip and the port, the plurality of coupling members being spaced apart from each other along a circumferential direction of the port; and a plurality of springs that are configured to move together with the plurality of coupling members, respectively, the plurality of springs being spaced apart from each other along the circumferential direction of the port.

According to an embodiment of the present disclosure, a wearable electronic device may include: a housing including a space; a port protruding at least partially outward from the housing; an eartip connected to the port and including an opening; a speaker inside the housing and configured to output sound toward the opening of the eartip; a coupling member connecting the eartip and the port; and a mesh member connected to the eartip, the mesh member being closer than the coupling member to the opening.

### BRIEF DESCRIPTION OF DRAWINGS

The above-described aspects and other aspects, configurations, and/or advantages regarding embodiments of the present disclosure may become more apparent through the following detailed description made with reference to the accompanying drawings.

FIG. 1 is a block diagram of an electronic device according to various embodiments in a network environment.

FIG. 2 is a block diagram of an audio module according to various embodiments;

FIG. 3 is a perspective view illustrating a wearable electronic device according to an embodiment of the present disclosure.

FIG. 4 is a cross-sectional view illustrating a wearable electronic device according to an embodiment of the present disclosure.

FIG. 5 is a portion of a cross-sectional view of a wearable electronic device according to an embodiment of the present disclosure.

FIG. 6 is a view illustrating a portion of a wearable electronic device according to an embodiment of the present disclosure.

FIG. 7 is a view illustrating a portion of the wearable electronic device according to an embodiment of the present disclosure.

FIG. 8 is a view illustrating a portion of the wearable electronic device according to an embodiment of the present disclosure.

FIG. 9 is a view illustrating a portion of a wearable electronic device according to an embodiment of the present disclosure.

FIG. 10 is a view illustrating a portion of the wearable electronic device according to an embodiment of the present disclosure.

FIG. 11 is a view illustrating a portion of the wearable electronic device according to an embodiment of the present disclosure.

FIG. 12 is a view illustrating a portion of a wearable electronic device according to an embodiment of the present disclosure.

FIG. 13 is a view illustrating a portion of the wearable electronic device according to an embodiment of the present disclosure.

FIG. 14 is a perspective view of an eartip according to an embodiment of the present disclosure.

FIG. 15 is a view illustrating an eartip according to an embodiment of the present disclosure.

FIG. 16 is a cross-sectional view illustrating the eartip according to an embodiment of the present disclosure.

FIG. 17 is a view illustrating an eartip according to an embodiment of the present disclosure.

FIG. 18 is a cross-sectional view of the eartip according to an embodiment of the present disclosure.

FIG. 19 is a view illustrating deformation of a spring according to an embodiment of the present disclosure.

FIG. 20 is a view illustrating a portion of a wearable electronic device according to an embodiment of the present disclosure.

FIG. 21 is a view illustrating a portion of a wearable electronic device according to an embodiment of the present disclosure.

FIG. 22 is a view illustrating a portion of a wearable electronic device according to an embodiment of the present disclosure.

FIG. 23 is a view illustrating a portion of the wearable electronic device according to an embodiment of the present disclosure.

FIG. 24 is a view illustrating a portion of a wearable electronic device according to an embodiment of the present disclosure.

FIG. 25 is a view illustrating an eartip according to an embodiment of the present disclosure.

FIG. 26 is a cross-sectional view of the eartip according to an embodiment of the present disclosure.

FIG. 27 is a view illustrating deformation of a spring according to an embodiment of the present disclosure.

Throughout the appended drawings, like reference numerals may be assigned to like components, configurations, and/or structures.

### DETAILED DESCRIPTION

The following description with reference to the accompanying drawings may provide an understanding of various non-limiting example embodiments of the present disclosure, including their equivalents. An example embodiment disclosed in the following description includes various specific details to help understanding, but is considered to be one of various non-limiting example embodiments. Accordingly, it will be understood by a person ordinarily skilled in the art that various implementations described herein may be variously changed and modified without departing from the spirit and scope of the present disclosure. In addition, descriptions of well-known functions and configurations may be omitted for clarity and brevity.

The terms and words used in the following description and claims are not limited to a bibliographical meaning, but may be used to describe an embodiment of the present disclosure clearly and consistently. Accordingly, it will be apparent to those skilled in the art that the following description of various example embodiments of the present disclosure is provided for explanatory purposes and not intended to limit the scope of the present disclosure and equivalents thereof.

Unless the context clearly indicates otherwise, the singular forms of “a,” “an,” and “the” should be understood to include the plural meaning. Accordingly, for example, the term “a component surface” may be understood to include one or more surfaces of the component.

It will be understood that when an element or layer is referred to as being “on,” “connected to,” or “coupled to” another element or layer, it can be directly on, connected to, or coupled to the other element or layer or intervening elements or layers may be present. In contrast, when an element or layer is referred to as being “directly on,” “directly connected to,” or “directly coupled to” another element or layer, there are no intervening elements or layers present.

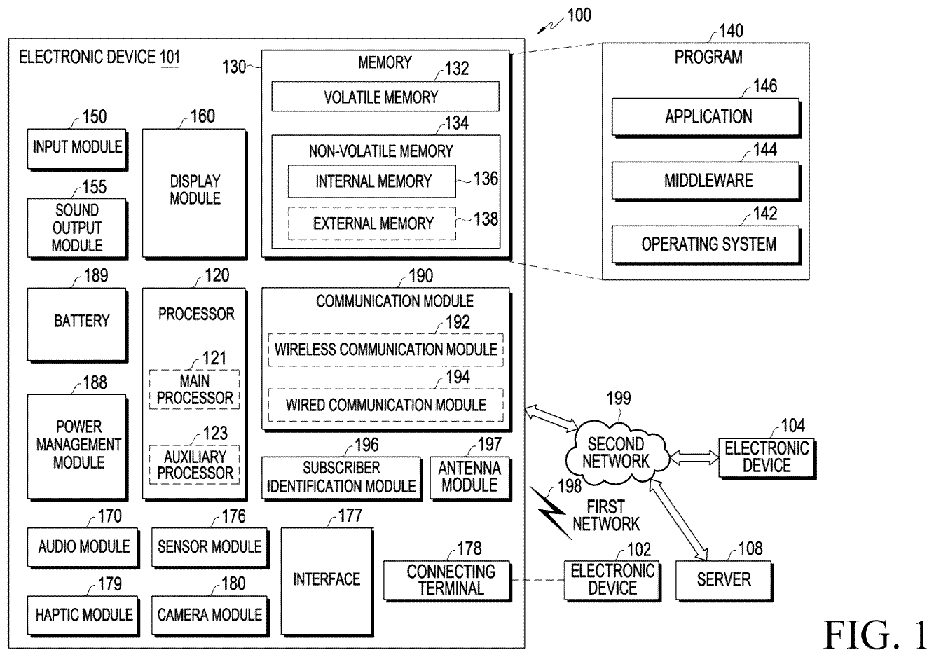

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160). The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

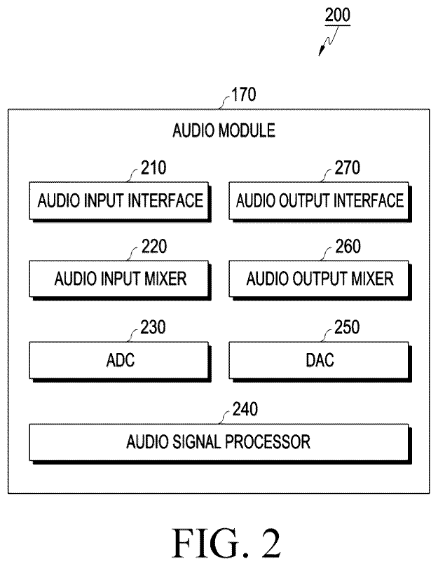

FIG. 2 is a block diagram 200 illustrating the audio module 170 according to various embodiments. Referring to FIG. 2, the audio module 170 may include, for example, an audio input interface 210, an audio input mixer 220, an analog-to-digital converter (ADC) 230, an audio signal processor 240, a digital-to-analog converter (DAC) 250, an audio output mixer 260, or an audio output interface 270.

The audio input interface 210 may receive an audio signal corresponding to a sound obtained from the outside of the electronic device 101 via a microphone (e.g., a dynamic microphone, a condenser microphone, or a piezo microphone) that is configured as part of the input device 150 or separately from the electronic device 101. For example, if an audio signal is obtained from the external electronic device 102 (e.g., a headset or a microphone), the audio input interface 210 may be connected with the external electronic device 102 directly via the connecting terminal 178, or wirelessly (e.g., Bluetooth™ communication) via the wireless communication module 192 to receive the audio signal. According to an embodiment, the audio input interface 210 may receive a control signal (e.g., a volume adjustment signal received via an input button) related to the audio signal obtained from the external electronic device 102. The audio input interface 210 may include a plurality of audio input channels and may receive a different audio signal via a corresponding one of the plurality of audio input channels, respectively. According to an embodiment, additionally or alternatively, the audio input interface 210 may receive an audio signal from another component (e.g., the processor 120 or the memory 130) of the electronic device 101.

The audio input mixer 220 may synthesize a plurality of inputted audio signals into at least one audio signal. For example, according to an embodiment, the audio input mixer 220 may synthesize a plurality of analog audio signals inputted via the audio input interface 210 into at least one analog audio signal.

The ADC 230 may convert an analog audio signal into a digital audio signal. For example, according to an embodiment, the ADC 230 may convert an analog audio signal received via the audio input interface 210 or, additionally or alternatively, an analog audio signal synthesized via the audio input mixer 220 into a digital audio signal.

The audio signal processor 240 may perform various processing on a digital audio signal received via the ADC 230 or a digital audio signal received from another component of the electronic device 101. For example, according to an embodiment, the audio signal processor 240 may perform changing a sampling rate, applying one or more filters, interpolation processing, amplifying or attenuating a whole or partial frequency bandwidth, noise processing (e.g., attenuating noise or echoes), changing channels (e.g., switching between mono and stereo), mixing, or extracting a specified signal for one or more digital audio signals. According to an embodiment, one or more functions of the audio signal processor 240 may be implemented in the form of an equalizer.

The DAC 250 may convert a digital audio signal into an analog audio signal. For example, according to an embodiment, the DAC 250 may convert a digital audio signal processed by the audio signal processor 240 or a digital audio signal obtained from another component (e.g., the processor(120) or the memory(130)) of the electronic device 101 into an analog audio signal.

The audio output mixer 260 may synthesize a plurality of audio signals, which are to be outputted, into at least one audio signal. For example, according to an embodiment, the audio output mixer 260 may synthesize an analog audio signal converted by the DAC 250 and another analog audio signal (e.g., an analog audio signal received via the audio input interface 210) into at least one analog audio signal.

The audio output interface 270 may output an analog audio signal converted by the DAC 250 or, additionally or alternatively, an analog audio signal synthesized by the audio output mixer 260 to the outside of the electronic device 101 via the sound output device 155. The sound output device 155 may include, for example, a speaker, such as a dynamic driver or a balanced armature driver, or a receiver. According to an embodiment, the sound output device 155 may include a plurality of speakers. In such a case, the audio output interface 270 may output audio signals having a plurality of different channels (e.g., stereo channels or 5.1 channels) via at least some of the plurality of speakers. According to an embodiment, the audio output interface 270 may be connected with the external electronic device 102 (e.g., an external speaker or a headset) directly via the connecting terminal 178 or wirelessly via the wireless communication module 192 to output an audio signal.

According to an embodiment, the audio module 170 may generate, without separately including the audio input mixer 220 or the audio output mixer 260, at least one digital audio signal by synthesizing a plurality of digital audio signals using at least one function of the audio signal processor 240.

According to an embodiment, the audio module 170 may include an audio amplifier (not shown) (e.g., a speaker amplifying circuit) that is capable of amplifying an analog audio signal inputted via the audio input interface 210 or an audio signal that is to be outputted via the audio output interface 270. According to an embodiment, the audio amplifier may be configured as a module separate from the audio module 170.

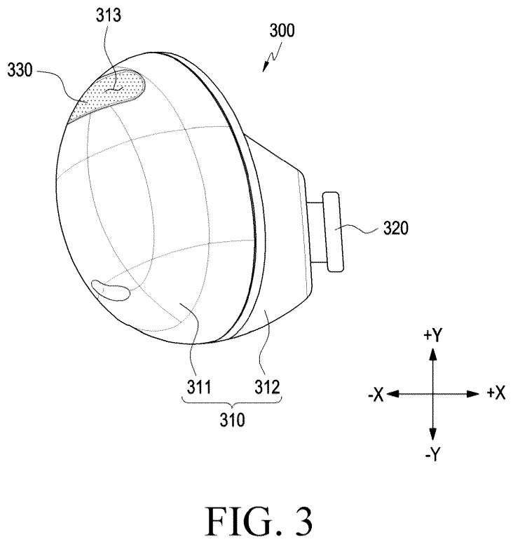

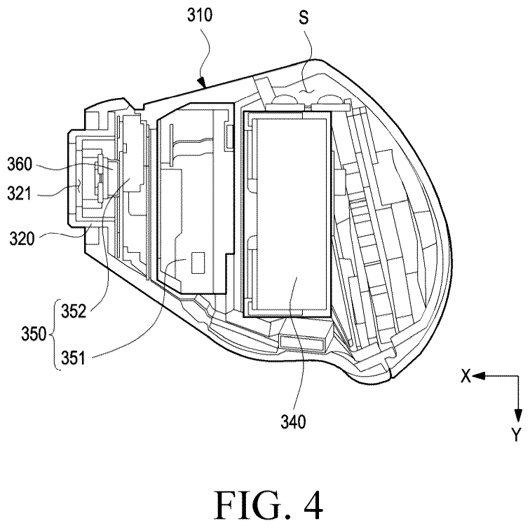

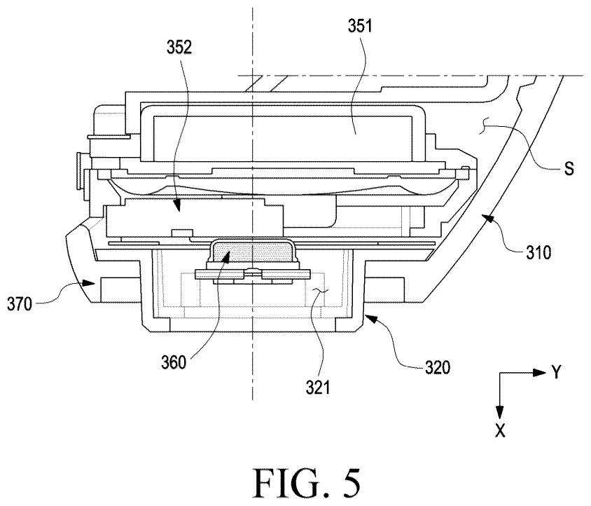

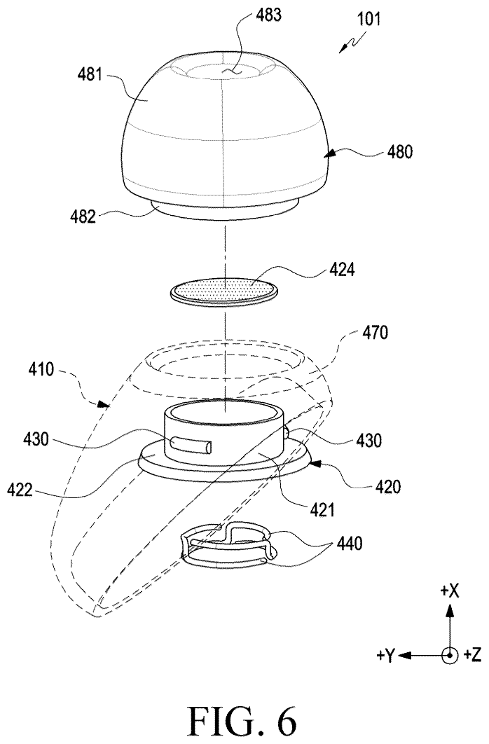

FIG. 3 is a perspective view illustrating a wearable electronic device 300. FIG. 4 is a cross-sectional view illustrating the wearable electronic device 300 illustrated in FIG. 3. FIG. 5 is a view illustrating a portion of the cross section illustrated in FIG. 4. The components described with reference to FIGS. 3, 4, and 5 may be partially or entirely the same as the components described with reference to FIGS. 1 and 2. The components described with reference to FIGS. 3, 4, and 5 may be partially or entirely the same as the components described with reference to FIGS. 6 to 27. The wearable electronic device 300 illustrated in FIGS. 3, 4, and 5 may be in a state in which an eartip (e.g., an eartip 480 of FIGS. 6 to 27) is not coupled.

According to an embodiment, the wearable electronic device 300 may include a housing 310. A space may be provided inside the housing 310. The housing 310 may form the exterior of the wearable electronic device 300. The housing 310 may include a first housing 311 and a second housing 312. The first housing 311 and the second housing 312 may be configured integrally.

According to an embodiment, the wearable electronic device 300 may include a housing opening 313 and a grill 330. The housing opening 313 may be formed in the housing 310. The grill 330 may be disposed in the housing opening 313.

According to an embodiment, the wearable electronic device 300 may include a port 320. The port 320 may be coupled to the housing 310. The port 320 may be coupled to the second housing 312. The port 320 may protrude outward from the housing 310.

According to an embodiment, a space S may be formed inside the housing 310. The wearable electronic device 300 may include a battery 340. The battery 340 may be disposed in the space S inside the housing 310. The battery 340 may supply power to at least one speaker 350 and a microphone 360.

According to an embodiment, the wearable electronic device 300 may include the at least one speaker 350 and the microphone 360. The at least one speaker 350 and the microphone 360 may be placed inside the housing 310. The at least one speaker 350 may include a first speaker 351 and a second speaker 352. One from among the first speaker 351 and the second speaker 352 may output sound of a high-frequency range, and the other may output sound of a low-frequency range. The microphone 360 may be used to perform an active noise cancellation (ANC) function. The microphone 360 may receive external sound outside the port 320.

According to an embodiment, the wearable electronic device 300 may include the port 320 and an acoustic conduit 321 formed inside the port 320. The acoustic conduit 321 may be in communication with an external space of the wearable electronic device 300. The speaker 350 may output sound to the outside of the wearable electronic device 300 through the acoustic conduit 321. The microphone 360 may receive external sound of the wearable electronic device 300 through the acoustic conduit 321.

According to an embodiment, the wearable electronic device 300 may include a support member 370. The support member 370 may be a portion of the housing 310. The port 320 may be coupled to the support member 370.

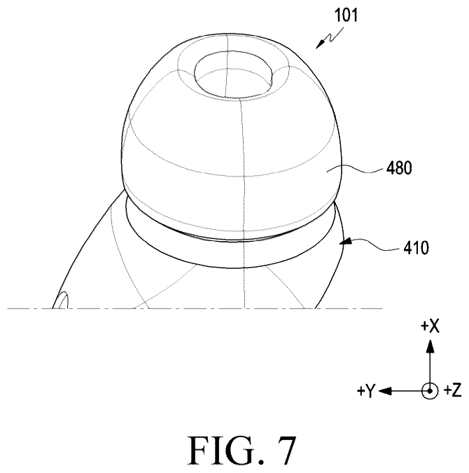

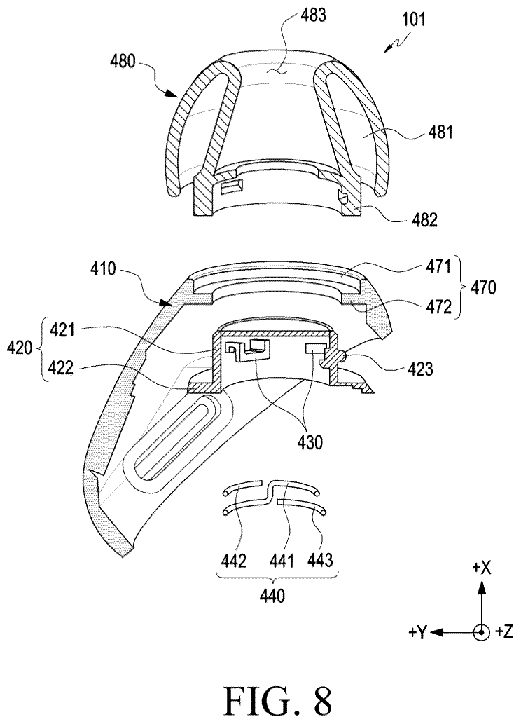

FIG. 6 is an exploded view of a portion of a housing 410, a port 420, a coupling member 430, a spring 440, and an eartip 480. FIG. 7 is a view of a portion of the wearable electronic device 101 in a state in which the eartip 480 and the port 420 are coupled. The components to be described with reference to FIGS. 6 and 7 may be partially or wholly the same as the components described with reference to FIGS. 1 to 5. The components to be described with reference to FIGS. 6 and 7 may be partially or wholly the same as the components to be described with reference to FIGS. 8 to 27.

According to an embodiment, the wearable electronic device 101 may include a housing 410 and a port 420. The description of the housing 410 and the port 420 may be understood based on the description of the components (e.g., the housing 310 and the port 320) provided with reference to FIGS. 1 to 5. The port 420 may be coupled to the housing 410.

According to an embodiment, the wearable electronic device 101 may include a support member 470. The description of the support member 470 may be the same as or similar to the description of the support member 370 provided with reference to FIGS. 1 to 5. The support member 470 may be a portion of the housing 410. The port 420 may be coupled to the support member 470.

According to an embodiment, the port 420 may include a port wall 421 and a rim portion 422. The port wall 421 may form a space therein. The port wall 421 may be cylindrical. The rim portion 422 may contact (e.g., be seated on) the support member 470. The rim portion 422 may extend along a circumferential direction of the port wall 421. The rim portion 422 may at least partially surround the port wall 421. The rim portion 422 may be annular.

According to an embodiment, the wearable electronic device 101 may include a coupling member 430. At least a portion of the coupling member 430 may be disposed inside the port wall 421. At least a portion of the coupling member 430 may protrude outward from the port wall 421. The coupling member 430 may be connected to the eartip 480.

According to an embodiment, the wearable electronic device 101 may include a spring 440. The spring 440 may be connected to the coupling member 430. The spring 440 may be deformably disposed inside the port wall 421. The spring 440 may be deformed when the eartip 480 and the coupling member 430 are coupled.

According to an embodiment, the wearable electronic device 101 may include an eartip 480. The eartip 480 may be coupled to the port 420. The eartip 480 may be connected to the coupling member 430. The eartip 480 may include an eartip body 481. The eartip body 481 may extend along a circumferential direction of the port 420. The eartip 480 may include a holding portion 482. The holding portion 482 may be connected to the eartip body 481. At least a portion of the coupling member 430 may be inserted into the holding portion 482. The eartip 480 may include an opening 483. The opening 483 may be in communication with an acoustic conduit (e.g., the acoustic conduit 321 of FIG. 5). Sound output from the at least one speaker (e.g., the at least one speaker 350 of FIG. 4) may be transmitted to the outside of the wearable electronic device 101 through the opening 483.

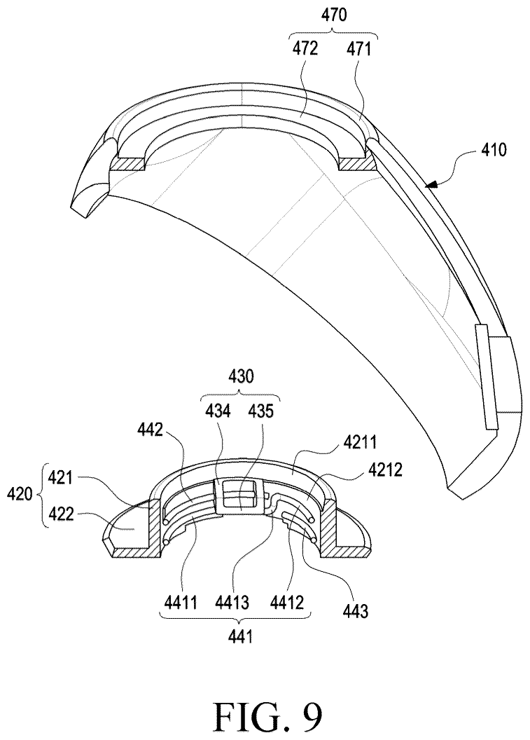

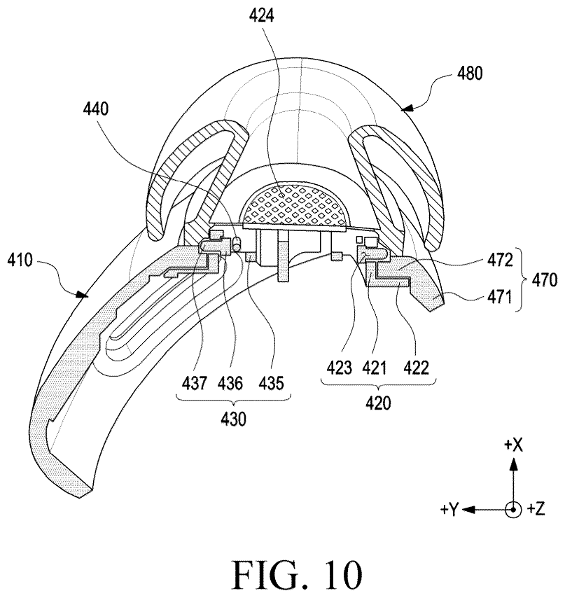

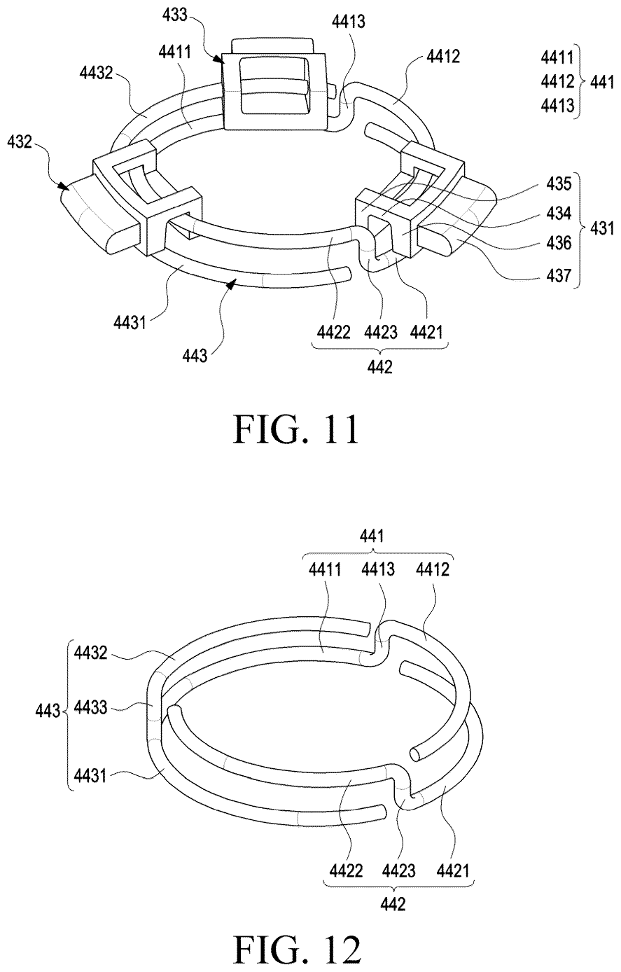

FIG. 8 is a cross-sectional view of the structure illustrated in FIG. 6. FIG. 9 is a view illustrating a cross-section of a portion of the structure illustrated in FIG. 6. FIG. 10 is a cross-sectional view of the structure illustrated in FIG. 7. The components described with reference to FIGS. 8 to 10 may be partially or entirely the same as the components described with reference to FIGS. 1 to 7. The components described with reference to FIGS. 8 to 10 may be partially or entirely the same as the components described with reference to FIGS. 11 to 27.

According to an embodiment, the port 420 may include a port wall 421 and a rim portion 422. A space may be formed inside the port wall 421. The coupling member 430 may be disposed inside the port wall 421. The port 420 may include a port hole 423. The port hole 423 may be formed as an opening in the port wall 421. A plurality of port holes 423 may be formed in the portion 420, and may be spaced apart from each other. At least a portion of the coupling member 430 may pass through the port hole 423.

According to an embodiment, a plurality of coupling members 430 may be disposed. The plurality of coupling members 430 may be spaced apart from each other along the circumferential direction of the port 420. For example, three coupling members 430 may be disposed, but the number of coupling members 430 is not limited thereto. For example, the coupling member 430 may include two coupling members spaced apart from each other along the circumferential direction of the port 420. For example, the coupling member 430 may be one, or more than three may be disposed. A plurality of springs 440 may be disposed. The plurality of springs 440 may correspond to the plurality of coupling members 430, respectively. For example, three coupling members 430 may be disposed, and three springs 440 may be disposed to correspond to the three coupling members 430. The number of springs 440 is not limited to the above. For example, the springs 440 may include two springs spaced apart from each other. The number of springs 440 may be the same as the number of coupling members 430. The springs 440 may include a first spring 441, a second spring 442, and a third spring 443.

According to an embodiment, the port wall 421 may be cylindrical. The port wall 421 may include a first portion 4211 and a second portion 4212. The first portion 4211 and the second portion 4212 may be integrally formed. The first portion 4211 may include an end portion of the port wall 421, and the second portion 4212 may be spaced apart from the end portion. The coupling member 430 may be connected to the second portion 4212. The coupling member 430 may include a connecting portion 434. The connecting portion 434 may connect a first wall 435 and a second wall 436. The connecting portion 434 may extend radially inward of the port wall 421. A protrusion 437 of the coupling member 430 may penetrate the second portion 4212 of the port wall 421. The port hole 423 may be formed in the second portion 4212 of the port wall 421.

According to an embodiment, the springs 440 may include a first spring, a second spring, and a third spring 441, 442, and 443. The shapes of the first spring 441, the second spring 442, and the third spring 443 may be substantially the same as each other. The springs 440 may be disposed at an inner side of the port wall 421. The springs 440 may be in contact with an inner surface of the port wall 421. The springs 440 may be supported by the coupling member 430. At least a portion of the springs 440 may be positioned between the first wall 435 and the second wall 436. At least a portion of the springs 440 may be in contact with (e.g., seated on) the connecting portion 434. By way of example, referring to the first spring 441, the first spring 441 may include a (1-1)^{th} spring portion 4411, a (1-2)^{th} spring portion 4412, and a first bending portion 4413. The first bending portion 4413 may include a bent shape. For example, the bent shape of the first bending portion 4413 may at least partially extend, in an axial direction of the port 420, from the (1-1)^{th} spring portion 4411 and the (1-2)^{th} spring portion 4412. The first bending portion 4413 may connect the (1-1)^{th} spring portion 4411 and the (1-2)^{th} spring portion 4412. The (1-2)^{th} spring portion 4412 may be positioned closer than the (1-1)^{th} spring portion 4411 to the first portion 4211 of the port wall 421. The (1-1)^{th} spring portion 4411 may be positioned between the first wall 435 and the second wall 436.

According to an embodiment, the support member 470 may include a first support portion 471 and a second support portion 472. The first support portion 471 may be cylindrical. The first support portion 471 may include an end portion of the housing 410. A space may be formed inside the first support portion 471. The second support portion 472 may protrude radially inward from the first support portion 471. The second support portion 472 may be annular. A space may be formed inside the second support portion 472. The port wall 421 of the port 420 may be inserted into the inside of the first support portion 471. The rim portion 422 of the port 420 may contact (e.g., be seated on) the second support portion 472.

According to an embodiment, the eartip body 481 may cover at least a portion of the support member 470. The holding portion 482 may contact (e.g., be seated on) the second support portion 472. The holding portion 482 may be positioned between the support member 470 and the port wall 421. At least a portion of the coupling member 430 may pass through the port hole 423 and be inserted into the holding portion 482.

According to an embodiment, the coupling member 430 may include a first wall 435 and a second wall 436. The first wall 435 and the second wall 436 may be spaced apart from each other. The spring 440 may be disposed between the first wall 435 and the second wall 436. The second wall 436 may be positioned closer to the port wall 421 than the first wall 435 with respect to the spring 440. The coupling member 430 may include a protrusion 437. The protrusion 437 may protrude from the second wall 436. The protrusion 437 may penetrate the port hole 423. The protrusion 437 may be inserted into the holding portion 482. The protrusion 437 may be fixed by contact (e.g., interference) with the holding portion 482.

According to an embodiment, the wearable electronic device 101 may include a mesh member 424. The mesh member 424 may be disposed inside the eartip 480. The mesh member 424 may be coupled to the port wall 421. The mesh member 424 may cover an acoustic conduit (e.g., the acoustic conduit 321 of FIG. 5) formed inside the port wall 421.

According to an embodiment, the mesh member 424 may be coupled to the eartip 480. The expression “coupled” (or “connected”) may include a case where a first component (e.g., the mesh member 424) is integrally formed with a second component (e.g., the eartip 480). For example, the mesh member 424 may constitute a part of the eartip 480. The eartip 480 may include an eartip body 481 and a holding portion 482. The eartip body 481 and the holding portion 482 may be integrally formed, or may be assembled to be separable from each other. A material of the eartip body 481 and a material of the holding portion 482 may be different from each other. For example, the eartip body 481 may include a rubber material, and the holding portion 482 may include a plastic material. A hardness of the eartip body 481 may be less than a hardness of the holding portion 482. The mesh member 424 may be coupled to the holding portion 482. In a state in which the mesh member 424 is coupled to the eartip 480, the mesh member 424 may be spaced apart from the coupling member 430. The mesh member 424 may be positioned closer than the coupling member 430 to an end portion of the eartip 480.

According to an embodiment, the mesh member 424 may be a part of the eartip 480. The eartip 480 may include the eartip body 481 and the holding portion 482. The eartip body 481 may have a first hardness, and the holding portion 482 may have a second hardness greater than the first hardness. The eartip body 481 may include a flexible material, and may include a silicone material. The holding portion 482 may include a rigid material and may include a plastic material (for example, polycarbonate (PC)). The mesh member 424 may be integrally formed with the eartip body 481. The mesh member 424 may have the first hardness. The mesh member 424 may include a flexible material and may include a silicone material. The eartip body 481, the holding portion 482, and the mesh member 424 may be integrally formed. The eartip body 481, the holding portion 482, and the mesh member 424 may be integrally manufactured and may be manufactured by a dual injection molding process.

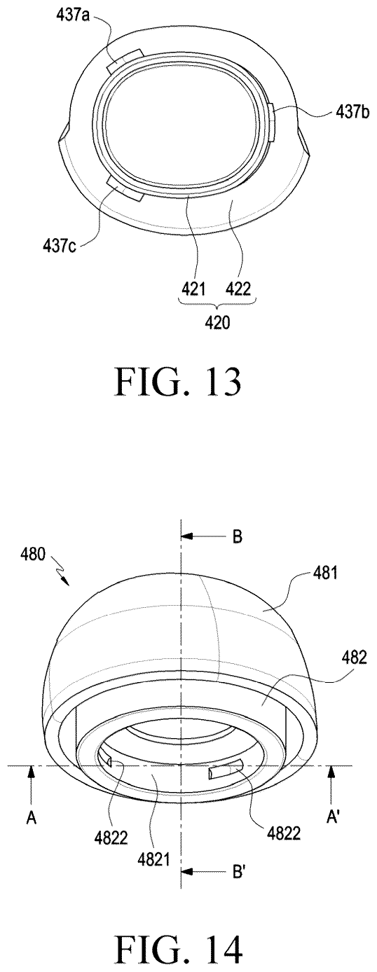

FIG. 11 is a view illustrating the coupling member 430 and the spring 440 according to an embodiment of the present disclosure. FIG. 12 is a view illustrating the spring 440 according to an embodiment of the present disclosure. FIG. 13 is a view illustrating a state in which the port 420 and the coupling member 430 are coupled. Components described with reference to FIGS. 11 to 13 may be partially or entirely the same as the components described with reference to FIGS. 1 to 10. Components described with reference to FIGS. 11 to 13 may be partially or entirely the same as the components described with reference to FIGS. 14 to 27.

According to an embodiment, the coupling member 430 may include a connecting portion 434, a first wall 435, a second wall 436, and a protrusion 437. A plurality of coupling members 430 may be disposed. A plurality of coupling members (e.g., a first coupling member 431, a second coupling member 432, a the third coupling member 433) may be spaced apart from each other along a circumferential direction of the port (e.g., the port 420 of FIG. 6). Each of the plurality of coupling members (e.g., the first coupling member 431, the second coupling member 432, and the third coupling member 433) may include a connecting portion 434, a first wall 435, a second wall 436, and a protrusion 437. The protrusion 437 may protrude radially outward from the second wall 436 of the port 420. The coupling members 430 may include a first coupling member 431, a second coupling member 432, and a third coupling member 433 that are spaced apart from each other.

According to an embodiment, a plurality of springs 440 may be disposed. The spring s440 may include a first spring 441, a second spring 442, and a third spring 443. Each of the first spring 441, the second spring 442, and the third spring 443 may extend along a circumferential direction of the port (e.g., the port 420 of FIG. 6). The first spring 441 may be supported by the first coupling member 431. The second spring 442 may be supported by the second coupling member 432. The third spring 443 may be supported by the third coupling member 433.

According to an embodiment, the first spring 441 may include a (1-1)^{th} spring portion 4411, a (1-2)^{th} spring portion 4412, and a first bending portion 4413. The first bending portion 4413 may connect the (1-1)^{th} spring portion 4411 and the (1-2)^{th} spring portion 4412. The (1-2)^{th} spring portion 4412 may pass between the first wall 435 and the second wall 436 of the first coupling member 431. The (1-2)^{th} spring portion 4412 may contact (e.g., be seated on) the connecting portion 434 of the first coupling member 431. The (1-2)^{th} spring portion 4412 may be fitted between the first wall 435 and the second wall 436 of the first coupling member 431. The (1-1)^{th} spring portion 4411 may pass between the first wall 435 and the second wall 436 of the third coupling member 433. The (1-1)^{th} spring portion 4411 may be spaced apart from a (3-2)^{th} spring portion 4432 between the first wall 435 and the second wall 436 of the third coupling member 433. The (1-1)^{th} spring portion 4411 may overlap (e.g., in the axial direction) a (3-2)^{th} spring portion 4432, of the third spring 443, between the first wall 435 and the second wall 436 of the third coupling member 433. The first bending portion 4413 may be located between the first coupling member 431 and the third coupling member 433 in, for example, a circumferential direction.

According to an embodiment, the second spring 442 may include a (2-1)^{th} spring portion 4421, a (2-2)^{th} spring portion 4422, and a second bending portion 4423. The second bending portion 4423 may connect the (2-1)^{th} spring portion 4421 and the (2-2)^{th} spring portion 4422. The (2-2)^{th} spring portion 4422 may pass between the first wall 435 and the second wall 436 of the second coupling member 432. The (2-2)^{th} spring portion 4422 may contact (e.g., be seated on) the connecting portion 434 of the second coupling member 432. The (2-2)^{th} spring portion 4422 may be fitted between the first wall 435 and the second wall 436 of the second coupling member 432. The (2-1)^{th} spring portion 4421 may pass between the first wall 435 and the second wall 436 of the first coupling member 431. The (2-1)^{th} spring portion 4421 may be spaced apart from the (1-2)^{th} spring portion 4412 between the first wall 435 and the second wall 436 of the first coupling member 431. The (2-1)^{th} spring portion 4421 may overlap (e.g., in the axial direction) the (1-2)^{th} spring portion 4412 between the first wall 435 and the second wall 436 of the first coupling member 431. The second bending portion 4423 may be located between the first coupling member 431 and the second coupling member 432 in, for example, a circumferential direction.

According to an embodiment, the third spring 443 may include a (3-1)^{th} spring portion 4431, a (3-2)^{th} spring portion 4432, and a third bending portion 4433. The third bending portion 4433 may connect the (3-1)^{th} spring portion 4431 and the (3-2)^{th} spring portion 4432. The (3-2)^{th} spring portion 4432 may pass between the first wall 435 and the second wall 436 of the third coupling member 433. The (3-2)^{th} spring portion 4432 may contact (e.g., be seated on) the connecting portion 434 of the third coupling member 433. The (3-2)^{th} spring portion 4432 may be fitted between the first wall 435 and the second wall 436 of the third coupling member 433. The (3-1)^{th} spring portion 4431 may pass between the first wall 435 and the second wall 436 of the second coupling member 432. The (3-1)^{th} spring portion 4431 may be spaced apart from the (2-2)^{th} spring portion 4422 between the first wall 435 and the second wall 436 of the second coupling member 432. The (3-1)^{th} spring portion 4431 may overlap (e.g., in the axial direction) the (2-2)^{th} spring portion 4422 between the first wall 435 and the second wall 436 of the second coupling member 432. The third bending portion 4433 may be located between the second coupling member 432 and the third coupling member 433 in, for example, a circumferential direction.

According to an embodiment, between the first coupling member 431 and the second coupling member 432, the (2-2)^{th} spring portion 4422 and the (3-1)^{th} spring portion 4431 may be spaced apart from each other. Between the second coupling member 432 and the third coupling member 433, the (1-1)^{th} spring portion 4411 and the (3-2)^{th} spring portion 4432 may be spaced apart from each other. Between the first coupling member 431 and the third coupling member 433, the (1-2)^{th} spring portion 4412 and the (2-1)^{th} spring portion 4421 may be spaced apart from each other.

According to an embodiment, the (1-1)^{th} spring portion 4411, the (2-1)^{th} spring portion 4421, and the (3-1)^{th} spring portion 4431 may each be referred to as a “first spring portion.” The (1-2)^{th} spring portion 4412, the (2-2)^{th} spring portion 4422, and the (3-2)^{th} spring portion 4432 may each be referred to as a “second spring portion.” The first bending portion 4413, the second bending portion 4423, and the third bending portion 4433 may each be referred to as a “bending portion.”

According to an embodiment, protrusions (e.g., a first protrusion 437a, a second protrusion 437b, and a third protrusion 437c) of each of the plurality of coupling members (e.g., the first coupling member 431, the second coupling member 432, and the third coupling member 433) may penetrate the port wall 421 of the port 420. The protrusions (e.g., the first protrusion 437a, the second protrusion 437b, and the third protrusion 437c) of each of the plurality of coupling members (e.g., the first coupling member 431, the second coupling member 432, and the third coupling member 433) may protrude radially outward from the port wall 421. The protrusions (e.g., the first protrusion 437a, the second protrusion 437b, and the third protrusion 437c) of each of the plurality of coupling members (e.g., the first coupling member 431, the second coupling member 432, and the third coupling member 433) may be located radially outward of the mesh member 424 The protrusions (e.g., the first protrusion 437a, the second protrusion 437b, and the third protrusion 437c) of each of the plurality of coupling members (e.g., the first coupling member 431, the second coupling member 432, and the third coupling member 433) may face the rim portion 422. The first coupling member 431 may include the first protrusion 437a. The second coupling member 432 may include the second protrusion 437b. The third coupling member 433 may include the third protrusion 437c. The first protrusion 437a, the second protrusion 437b, and the third protrusion 437c may be spaced apart from each other in the circumferential direction of the port wall 421.

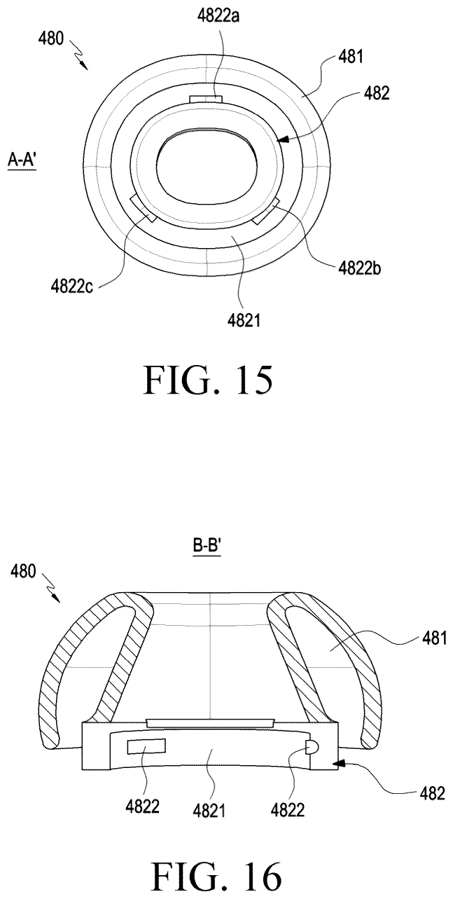

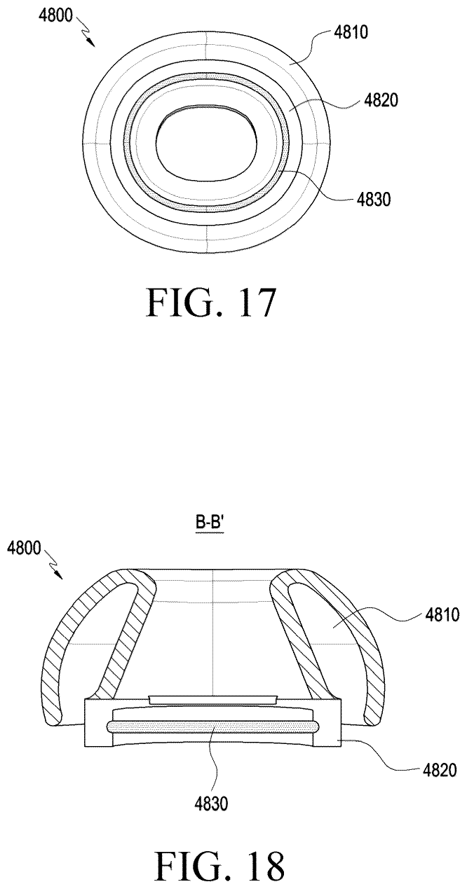

FIG. 14 is a perspective view of an eartip 480 according to an embodiment of the present disclosure. FIG. 15 is a cross-sectional view taken along a line A-A′ of the eartip 480 illustrated in FIG. 14. FIG. 16 is a cross-sectional view taken along a line B-B′ of the eartip 480 illustrated in FIG. 14. The components described with reference to FIGS. 14 to 16 may be partially or entirely the same as the components described with reference to FIGS. 1 to 13. The components described with reference to FIGS. 14 to 16 may be partially or entirely the same as the components described with reference to FIGS. 17 to 27.

According to an embodiment, the eartip 480 may include an eartip body 481 and a holding portion 482. The eartip body 481 may include a space therein. At least a portion of the holding portion 482 may be disposed in the space inside the eartip body 481. At least a portion of the holding portion 482 may be spaced radially inward from an inner surface of the eartip body 481.

According to an embodiment, the holding portion 482 may include an inner circumferential surface 4821. The inner circumferential surface 4821 may be an inner surface of the holding portion 482. The holding portion 482 may include a recess 4822. The recess 4822 may be recessed into the inner circumferential surface 4821 of the holding portion 482. A plurality of recesses 4822 may be disposed. The plurality of recesses 4822 may be spaced apart from each other in a circumferential direction of the holding portion 482.

According to an embodiment, the recesses 4822 of the holding portion 482 may include a first recess 4822a, a second recess 4822b, and a third recess 4822c. The first recess 4822a, the second recess 4822b, and the third recess 4822c may be spaced apart from each other in the circumferential direction of the holding portion 482. The number of the plurality of recesses 4822 (e.g., the first recess 4822a, the second recess 4822b, and the third recess 4822c) may correspond to the number of coupling members (e.g., coupling member 430 of FIGS. 1 to 13). For example, as illustrated in FIG. 11, three coupling members 430 may be disposed, and three recesses 4822 may be disposed to correspond to the plurality of coupling members 430, respectively. A first protrusion (e.g., the first protrusion 437a of FIG. 13) of a first coupling member (e.g., the first coupling member 431 of FIG. 11) may be inserted into a first recess 4822a. A second protrusion (e.g., the second protrusion 437b of FIG. 13) of a second coupling member (e.g., the second coupling member 432 of FIG. 11) may be inserted into a second recess 4822b. A third protrusion (e.g., the third protrusion 437c of FIG. 13) of a third coupling member (e.g., the third coupling member 433 of FIG. 11) may be inserted into a third recess 4822c.

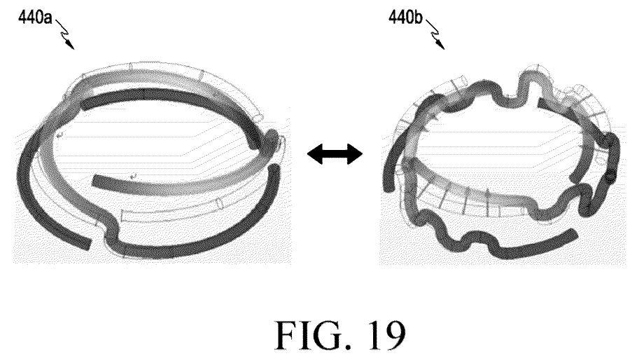

FIG. 17 is a view illustrating an eartip 4800 according to an embodiment of the present disclosure. FIG. 18 is a cross-sectional view of the eartip 4800 illustrated in FIG. 17. The components described with reference to FIGS. 17 and 18 may be partially or wholly the same as the components described with reference to FIGS. 1 to 16. The components to be described with reference to FIGS. 17 and 18 may be partially or wholly the same as the components to be described with reference to FIGS. 19 to 27.

According to an embodiment, the eartip 4800 may include an eartip body 4810 and a holding portion 4820. The description of the eartip body 4810 and the holding portion 4820 may be to the same as or similar to the description of the eartip body 481 and the holding portion 482 provided with reference to FIGS. 14 to 16.

According to an embodiment of the present disclosure, the eartip 4800 may include a recess 4830. The recess 4830 may be recessed in the holding portion 4820. The recess 4830 may extend along the circumference of the holding portion 4820. The recess 4830 may include a closed-loop shape. The recess 4830 may be annular. Protrusions (e.g., the first protrusion 437a, the second protrusion 437b, and the third protrusion 437c of FIG. 13) of a plurality of respective coupling members (e.g., the first coupling member 431, the second coupling member 432, and the third coupling member 433 of FIG. 11) may be inserted into the recess 4830. The protrusions (e.g., the first protrusion 437a, the second protrusion 437b, and the third protrusion 437c of FIG. 13) of the plurality of respective coupling members (e.g., the first coupling member 431, the second coupling member 432, and the third coupling member 433 of FIG. 11) may be disposed so as to be movable in the recess 4830 along the extending direction of the recess 4830. The eartip 4800 may be coupled to the port 420 (e.g., the port 420 of FIG. 6) so as to be movable along the circumferential direction of the port 420.

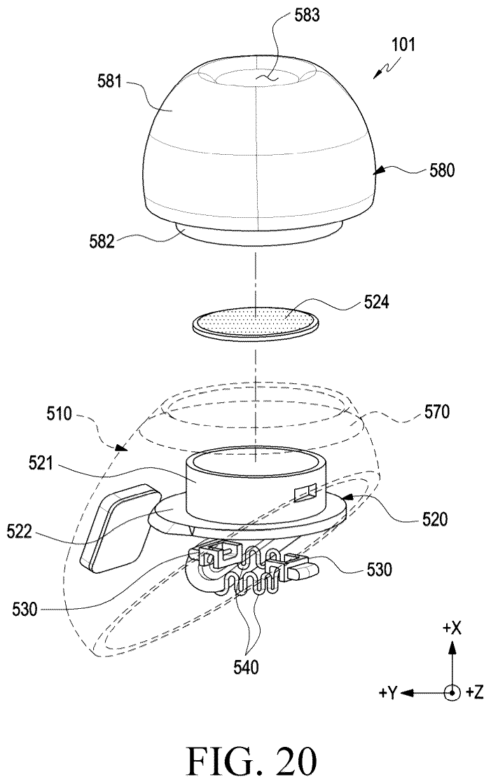

FIG. 19 illustrates contours respectively showing a distribution of external force acting on the spring 440 before deformation (see image 440a) and a distribution of external force acting on the spring 440 (e.g., the first spring 441, the second spring 442, and the third spring 443 of FIG. 12) after deformation (see image 440b), according to an embodiment of the present disclosure. The components to be described with reference to FIG. 19 may be partially or wholly the same as the components described with reference to FIGS. 1 to 18. The components to be described with reference to FIG. 19 may be partially or wholly the same as the components to be described with reference to FIGS. 20 to 27.

Referring to FIGS. 3 to 19, the eartip 480 may include a deformable material. The eartip 480 may include a rubber or plastic material. The eartip 480 may be deformed by interference with the coupling member 430. The spring 440 may be deformed by interference between the eartip 480 and the coupling member 430. When the eartip 480 is fixed to the port 420, the port 420 may move in a first direction (e.g., the +X direction of FIG. 6) toward the eartip 480. When the port 420 moves in the first direction (e.g., the +X direction of FIG. 6) toward the eartip 480, the holding portion 482 of the eartip 480 and the protrusion 437 of the coupling member 430 may interfere with each other. The protrusion 437 may be inserted into the recess 4822 of the holding portion 482. When the protrusion 437 interferes with the holding portion 482, the protrusion 437 may be pushed radially inward of the port 420. When the protrusion 437 is pushed radially inward of the port 420, the spring 440 disposed between the first wall 435 and the second wall 436 of the coupling member 430 may be deformed while moving together with the coupling member 430. When the protrusion 437 is inserted into the recess 4822 of the holding portion 482, the deformed spring 440 may push the protrusion 437 toward the recess 4822. The deformed spring 440 may apply a restoring force to the protrusion 437 in a direction toward the recess 4822.

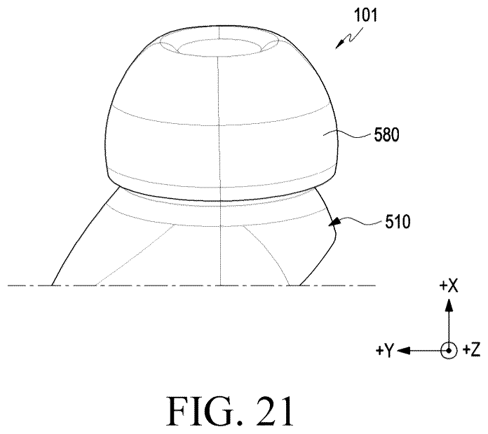

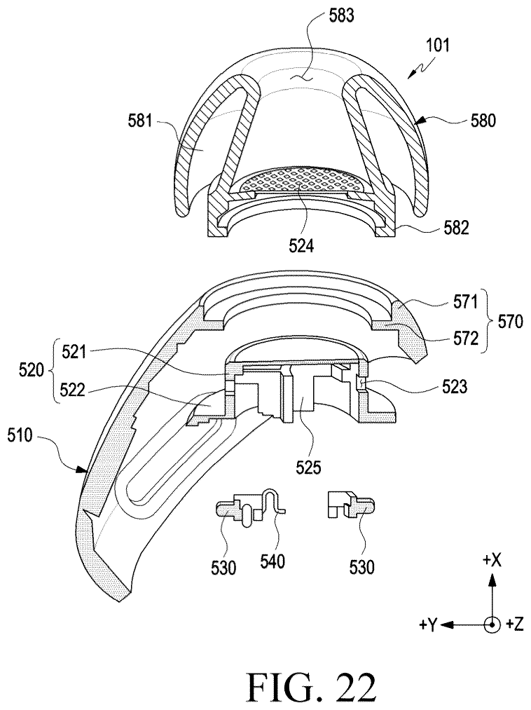

FIG. 20 is an exploded view of a portion of a housing 510, a port 520, a coupling member 530, a spring 540, and an eartip 580. FIG. 21 is a view of a portion of the wearable electronic device 101 in a state in which the eartip 580 and the port 520 are coupled. The components to be described with reference to FIGS. 20 and 21 may be partially or wholly the same as the components described with reference to FIGS. 1 to 19. The components to be described with reference to FIGS. 20 and 21 may be partially or wholly the same as the components to be described with reference to FIGS. 22 to 27.

According to an embodiment, the wearable electronic device 101 may include a housing 510 and a port 520. The description of the housing 510 and the port 520 may be the same as or similar to the description of the components (e.g., the housing 310, the port 320, the housing 410, the port 420) provided with reference to FIGS. 1 to 19. The port 520 may be coupled to the housing 510.

According to an embodiment, the wearable electronic device 101 may include a support member 570. The description of the support member 570 may be the same as or similar to the description of the support member 470 provided with reference to FIGS. 1 to 19. The support member 570 may be a portion of the housing 510. The port 520 may be coupled to the support member 570.

According to an embodiment, the port 520 may include a port wall 521 and a rim portion 522. The port wall 521 may form a space therein. The port wall 521 may be cylindrical. The rim portion 522 may contact (e.g., be seated on) the support member 570. The rim portion 522 may extend along a circumferential direction of the port wall 521. The rim portion 522 may surround the port wall 521. The rim portion 522 may be annular.

According to an embodiment, the wearable electronic device 101 may include a coupling member 530. At least a portion of the coupling member 530 may be disposed inside the port wall 521. At least a portion of the coupling member 530 may protrude outward from the port wall 521. The coupling member 530 may be connected to the eartip 580.

According to an embodiment, the wearable electronic device 101 may include a spring 540. The spring 540 may be connected to the coupling member 530. The spring 540 may be deformably disposed inside the port wall 521. The spring 540 may be deformed when the eartip 580 and the coupling member 530 are coupled.

According to an embodiment, the wearable electronic device 101 may include an eartip 580. The eartip 580 may be coupled to the port 520. The eartip 580 may be connected to the coupling member 530. The eartip 580 may include an eartip body 581. The eartip body 581 may extend along a circumferential direction of the port 520. The eartip 580 may include a holding portion 582. The holding portion 582 may be connected to the eartip body 581. At least a portion of the coupling member 530 may be inserted into the holding portion 582. The eartip 580 may include an opening 583. The opening 583 may be in communication with an acoustic conduit (e.g., the acoustic conduit 321 of FIG. 5). Sound output from the at least one speaker (e.g., the at least one speaker 350 of FIG. 4) may be transmitted to the outside of the wearable electronic device 101 through the opening 583.

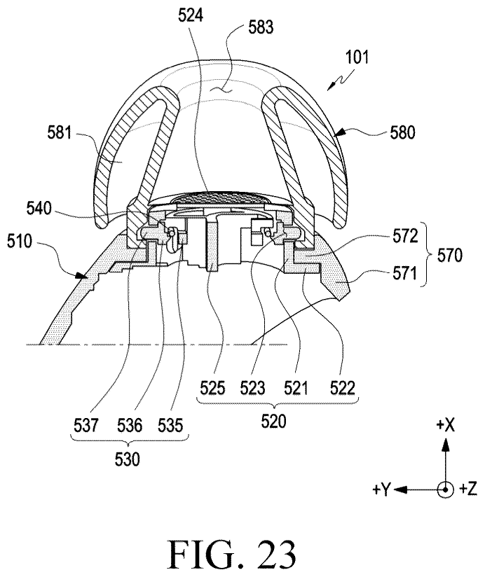

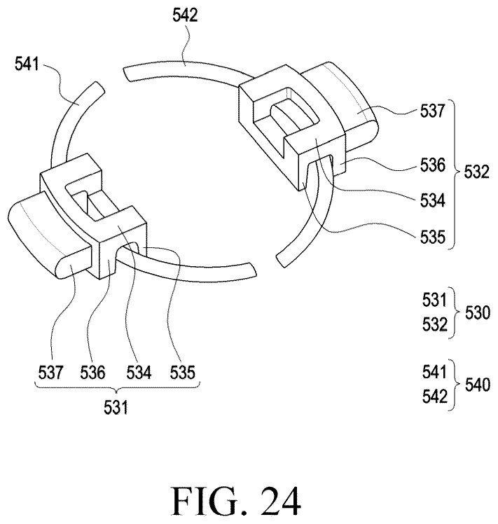

FIG. 22 is a cross-sectional view of the structure illustrated in FIG. 20. FIG. 23 is a cross-sectional view of the structure illustrated in FIG. 21. The components described with reference to FIGS. 22 and 23 may be partially or wholly the same as the components described with reference to FIGS. 1 to 21. The components to be described with reference to FIGS. 22 and 23 may be partially or wholly the same as the components to be described with reference to FIGS. 24 to 27.

According to an embodiment, the port 520 may include a port wall 521 and a rim portion 522. A space may be formed inside the port wall 521. The coupling member 530 may be disposed inside the port wall 521. The port 520 may include a port hole 523. The port hole 523 may be formed as an opening in the port wall 521. A plurality of port holes 523 may be formed and spaced apart from each other. At least a portion of the coupling member 530 may pass through the port hole 523.

According to an embodiment, a plurality of coupling members 530 may be disposed. The plurality of coupling members 530 may be spaced apart from each other along the circumferential direction of the port 520. Two coupling members 530 may be disposed, but the number of coupling members 530 is not limited thereto. A plurality of springs 540 may be disposed. The plurality of springs 540 may correspond to the plurality of coupling members 530, respectively. For example, two coupling members 530 may be disposed, and two springs 540 may be disposed to correspond to the two coupling members 530. The number of springs 540 may be the same as the number of coupling members 530.

According to an embodiment, the support member 570 may include a first support portion 571 and a second support portion 572. The first support portion 571 may be cylindrical. The first support portion 571 may include an end portion of the housing 510. A space may be formed inside the first support portion 571. The second support portion 572 may protrude radially inward from the first support portion 571. The second support portion 572 may be annular. A space may be formed inside the second support portion 572. The port wall 521 of the port 520 may be inserted into the inside of the first support portion 571. The rim portion 522 of the port 520 may be seated on the second support portion 572.

According to an embodiment, the eartip body 581 may cover at least a portion of the support member 570. The holding portion 582 may be seated on the second support portion 572. The holding portion 582 may be positioned between the support member 570 and the port wall 521. At least a portion of the coupling member 530 may pass through the port hole 523 and be inserted into the holding portion 582.

According to an embodiment, the coupling member 530 may include a first wall 535 and a second wall 536. The first wall 535 and the second wall 536 may be spaced apart from each other. The spring 540 may be disposed between the first wall 535 and the second wall 536. The second wall 536 may be positioned closer to the port wall 521 than the first wall 535 with respect to the spring 540. The coupling member 530 may include a protrusion 537. The protrusion 537 may protrude from the second wall 536. The protrusion 537 may penetrate the port hole 523. The protrusion 537 may be inserted into the holding portion 582. The protrusion 537 may be fixed by contact (e.g., interference) with the holding portion 582.

According to an embodiment, the wearable electronic device 101 may include a mesh member 524. The mesh member 524 may be disposed inside the eartip 580. The mesh member 524 may be coupled to the port wall 521. The mesh member 524 may cover an acoustic conduit (e.g., the acoustic conduit 321 of FIG. 5) formed inside the port wall 521.

According to an embodiment, the mesh member 524 may be coupled to the eartip 580. The expression “coupled” (or “connected”) may include a case where a first component (e.g., the mesh member 424) is integrally formed with a second component (e.g., the eartip 480). For example, the mesh member 424 may constitute a part of the eartip 480. The eartip 580 may include an eartip body 581 and a holding portion 582. The eartip body 581 and the holding portion 582 may be integrally formed, or may be assembled to be separable from each other. A material of the eartip body 581 and a material of the holding portion 582 may be different from each other. For example, the eartip body 581 may include a rubber material, and the holding portion 582 may include a plastic material. A hardness of the eartip body 581 may be less than a hardness of the holding portion 582. The mesh member 524 may be coupled to the holding portion 582. In a state in which the mesh member 524 is coupled to the eartip 580, the mesh member 424 may be spaced apart from the coupling member 530. The mesh member 524 may be positioned closer than the coupling member 530 to an end portion of the eartip 580.

According to an embodiment, the mesh member 524 may be a part of the eartip 580. The eartip 580 may include the eartip body 581 and the holding portion 582. The eartip body 581 may have a first hardness, and the holding portion 582 may have a second hardness greater than the first hardness. The eartip body 581 may include a flexible material, and may include a silicone material. The holding portion 582 may include a rigid material and may include a plastic material (for example, PC). The mesh member 524 may be integrally formed with the eartip body 581. The mesh member 524 may have the first hardness. The mesh member 524 may include a flexible material and may include a silicone material. The eartip body 581, the holding portion 582, and the mesh member 524 may be integrally formed. The eartip body 581, the holding portion 582, and the mesh member 524 may be integrally manufactured and may be manufactured by a dual injection molding process.

According to an embodiment, the port 520 may include a rib 525. The rib 525 may be disposed inside (e.g., at an inner side of) the port wall 521. The rib 525 may be disposed between a plurality of coupling members 530 that are spaced apart from each other. The rib 525 may partition a space in which the plurality of coupling members 530 spaced apart from each other are disposed. A microphone (e.g., the microphone 360 of FIG. 5) may be supported by the rib 525.

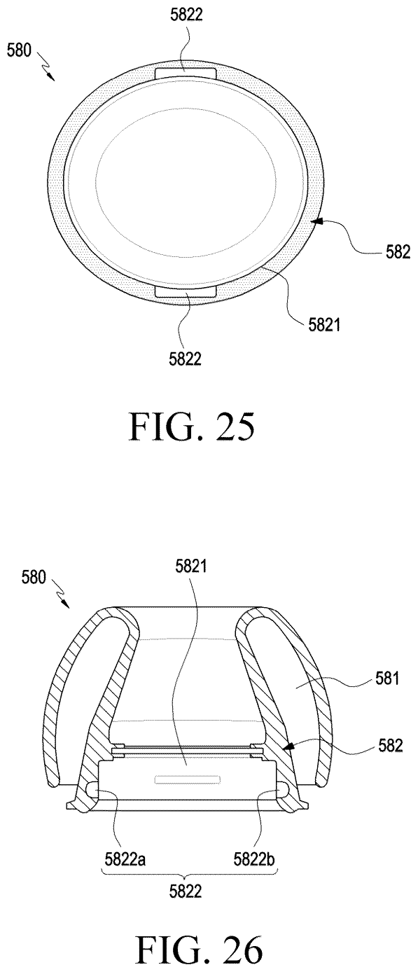

FIG. 24 is a view illustrating a coupling member 530 and a spring 540 according to an embodiment of the present disclosure. The components to be described with reference to FIG. 24 may be partially or wholly the same as the components described with reference to FIGS. 1 to 23. The components to be described with reference to FIG. 24 may be partially or wholly the same as the components to be described with reference to FIGS. 25 to 27.

According to an embodiment, a plurality of coupling members 530 may be disposed. The plurality of coupling members 530 may be spaced apart from each other in the circumferential direction of the port (e.g., the port 520 of FIG. 20). Two coupling members 530 may be disposed, but the number of coupling members 530 is not limited thereto. The coupling member 530 may include a first coupling member 531 and a second coupling member 532 that are spaced apart from each other.

According to an embodiment, each coupling member 530 may include a first wall 535, a second wall 536, and a protrusion 537. The first wall 535 and the second wall 536 may be spaced apart from each other. The protrusion 537 may protrude from the second wall 536. The protrusion 537 may protrude radially outward from the port (e.g., the port 520 of FIG. 20). The coupling member 530 may include a connecting portion 534. The connecting portion 534 may connect the first wall 535 and the second wall 536.

According to an embodiment, a plurality of springs 540 may be disposed. The spring 540 may extend along the circumferential direction of the port (e.g., the port 520 of FIG. 20). Two springs 540 may be disposed, but the number of springs 540 is not limited thereto. The number of springs 540 may correspond to the number of coupling members 530. For example, the springs 540 may include a first spring 541 corresponding to the first coupling member 531, and a second spring 542 corresponding to the second coupling member 532. Each of the first spring 541 and the second spring 542 may have an arc shape.

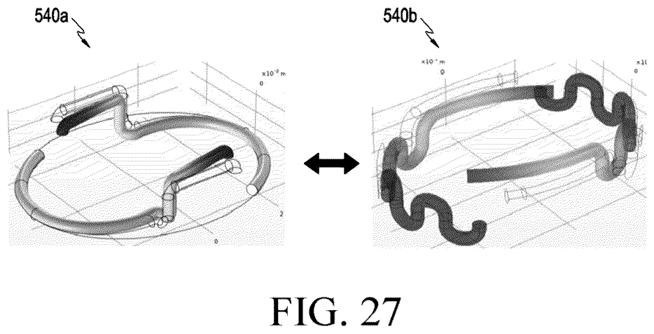

FIG. 25 is a side view of an eartip 580 according to an embodiment of the present disclosure. FIG. 26 is a cross-sectional view of the eartip 580 illustrated in FIG. 25. The components to be described with reference to FIGS. 25 and 26 may be partially or wholly the same as the components described with reference to FIGS. 1 to 24. The components to be described with reference to FIGS. 25 and 26 may be partially or wholly the same as the components to be described with reference to FIGS. 27 to 27.

According to an embodiment, the eartip 580 may include an eartip body 581 and a holding portion 582. At least a portion of the holding portion 582 may be located in the space inside the eartip body 581. The eartip body 581 may cover at least a portion of the holding portion 582.

According to an embodiment of the present disclosure, the holding portion 582 may include an inner circumferential surface 5821 and a recess 5822. The inner circumferential surface 5821 may be an inner surface of the holding portion 582. The recess 5822 may be recessed in the inner circumferential surface 5821. A plurality of recesses 5822 may be disposed. The plurality of recesses 5822 may be spaced apart from each other along the circumferential direction of the eartip 580. The number of recesses 5822 may correspond to the number of coupling members (e.g., the coupling members 530 of FIG. 24). For example, the recesses 5822 may include a first recess 5822a that contacts (e.g., interferes) with a first coupling member (e.g., the first coupling member 531 of FIG. 24), and a second recess 5822b that contacts (e.g., interferes) with a second coupling member (e.g., the second coupling member 532 of FIG. 24).

According to an embodiment of the present disclosure, a protrusion (e.g., the protrusion 537 of FIG. 24) of the coupling member (e.g., the coupling member 530 of FIG. 24) may be inserted into the recess 5822 of the eartip 580.

FIG. 27 illustrates contours respectively showing a distribution of external force acting on the spring 540 before deformation (see image 540a) and a distribution of external force acting on the spring 540 (e.g., the first spring 541 and the second spring 542 of FIG. 24) after deformation (see image 540b), according to an embodiment of the present disclosure. The components to be described with reference to FIG. 27 may be partially or wholly the same as the components to be described with reference to FIGS. 1 to 26.

Referring to FIGS. 20 to 27, the eartip 580 may include a deformable material. The eartip 580 may include a rubber or plastic material. The eartip 580 may be deformed by interference with the coupling member 530. The spring 540 may be deformed by interference between the eartip 580 and the coupling member 530. When the eartip 580 is fixed to the port 520, the port 520 may move in a first direction (e.g., the +X direction of FIG. 20) toward the eartip 580. When the port 520 moves in the first direction (e.g., the +X direction of FIG. 20) toward the eartip 580, the holding portion 582 of the eartip 580 and the protrusion 537 of the coupling member 530 may interfere with each other. The protrusion 537 may be inserted into the recess 5822 of the holding portion 582. When the protrusion 537 interferes with the holding portion 582, the protrusion 537 may be pushed radially inward of the port 520. When the protrusion 537 is pushed radially inward of the port 520, the spring 540 disposed between the first wall 535 and the second wall 536 of the coupling member 530 may be deformed while moving together with the coupling member 530. When the protrusion 537 is inserted into the recess 5822 of the holding portion 582, the deformed spring 540 may push the protrusion 537 toward the recess 5822. The deformed spring 540 may apply a restoring force to the protrusion 537 in a direction toward the recess 5822.

According to a comparative embodiment, a wearable electronic device may include a housing in which a battery and a speaker are disposed, and a port that includes an acoustic conduit through which sound generated from the speaker is transmitted. The wearable electronic device may be inserted into a user's ear and may include an eartip that surrounds the port. The size of the eartip may be determined based on the size of the port, and as the size of the port increases, the size of the eartip may also increase. The wearable electronic device may include a microphone that performs an active noise cancellation (ANC) function. The performance of the ANC function implemented by the microphone may improve as the area of the acoustic conduit of the port increases. When the sizes of the port and the eartip in the comparative embodiment are increased to enhance the ANC performance of the microphone, coupling between the enlarged eartip and the port may become difficult due to their increased sizes.

According to embodiments of the present disclosure, the sound reception performance of the microphone may be improved.

According to embodiments of the present disclosure, the eartip and the port may be firmly coupled.

The issues that embodiments of the present disclosure address are not limited to the aforementioned issues, and other issues may be solved by embodiments of the present disclosure without departing from the spirit and scope of the present disclosure.

The electronic device according to various embodiments of the present disclosure may increase the sound reception performance of the microphone by increasing the size of the port, while simultaneously ensuring a firm coupling between the port and the eartip.

The electronic device according to various embodiments of the present disclosure may increase the coupling force between the eartip and the coupling member by a restoring force of a spring.

The effects obtained by embodiments of the present disclosure are not limited to those described above, and other effects, not described above, obtained by embodiments of the present disclosure may be clearly understood by a person ordinarily skilled in the art to which the present disclosure belongs based on descriptions of the present disclosure.

According to an embodiment of the present disclosure, a wearable electronic device (e.g., the electronic device 101 of FIGS. 1 to 27) may include a housing (e.g., the housing 410 of FIGS. 1 to 27) having a space formed therein.

According to an embodiment of the present disclosure, the wearable electronic device (e.g., the electronic device 101 of FIGS. 1 to 27) may include a port (e.g., the port 420 of FIGS. 1 to 27) that at least partially protrudes outward from the housing (e.g., the housing 410 of FIGS. 1 to 27), and an eartip (e.g., the eartip 480 of FIGS. 1 to 27) having an opening (e.g., the opening 483 of FIGS. 1 to 27) may be coupled to the port.

According to an embodiment of the present disclosure, the wearable electronic device (e.g., the electronic device 101 of FIGS. 1 to 27) may include a speaker (e.g., the speaker 350 of FIGS. 1 to 27) disposed inside the housing (e.g., the housing 410 of FIGS. 1 to 27) and configured to output sound toward the opening (e.g., the opening 483 of FIGS. 1 to 27) of the eartip (e.g., the eartip 480 of FIGS. 1 to 27).

According to an embodiment of the present disclosure, the wearable electronic device (e.g., the electronic device 101 of FIGS. 1 to 27) may include a coupling member (e.g., the coupling member 430 of FIGS. 1 to 27) connecting the eartip (e.g., the eartip 480 of FIGS. 1 to 27) and the port (e.g., the port 420 of FIGS. 1 to 27).

According to an embodiment of the present disclosure, the eartip (e.g., the eartip 480 of FIGS. 1 to 27) may include a plurality of recesses (e.g., the recesses 4822 of FIGS. 1 to 27) into which at least a portion of the coupling member (e.g., the coupling member 430 of FIGS. 1 to 27) is inserted.

According to an embodiment of the present disclosure, the coupling member (e.g., the coupling member 430 of FIGS. 1 to 27) may include a plurality of coupling members (e.g., the coupling member 430 of FIGS. 1 to 27) spaced apart from each other along a circumferential direction of the eartip (e.g., the eartip 480 of FIGS. 1 to 27).

According to an embodiment of the present disclosure, the plurality of coupling members (e.g., the coupling members 430 of FIGS. 1 to 27) are configured to correspond to the plurality of recesses (e.g., the recesses 4822 of FIGS. 1 to 27), respectively.

According to an embodiment of the present disclosure, the plurality of recesses (e.g., the recesses 4822 of FIGS. 1 to 27) may be spaced apart from each other along a circumferential direction of the port (e.g., the port 420 of FIGS. 1 to 27).

According to an embodiment of the present disclosure, the port (e.g., the port 420 of FIGS. 1 to 27) may include a port wall (e.g., the port wall 421 of FIGS. 1 to 27) configured to accommodate at least a portion of the coupling member (e.g., the coupling member 430 of FIGS. 1 to 27).

According to an embodiment of the present disclosure, the coupling member (e.g., the coupling member 430 of FIGS. 1 to 27) may include a protrusion (e.g., the protrusion 437 of FIGS. 1 to 27) configured to penetrate the port wall (e.g., the port wall 421 of FIGS. 1 to 27) and to be inserted into the recess (e.g., the recesses 4822 of FIGS. 1 to 27).

According to an embodiment of the present disclosure, the eartip (e.g., the eartip 480 of FIGS. 1 to 27) includes a holding portion (e.g., the holding portion 482 of FIGS. 1 to 27) configured to surround the port (e.g., the port 420 of FIGS. 1 to 27), and in which the plurality of recesses (e.g., the recesses 4822 of FIGS. 1 to 27) are formed.

According to an embodiment of the present disclosure, the coupling member (e.g., the coupling member 430 of FIGS. 1 to 27) may include a first wall (e.g., the first wall 435 of FIGS. 1 to 27).

According to an embodiment of the present disclosure, the coupling member (e.g., the coupling member 430 of FIGS. 1 to 27) may include a second wall (e.g., the second wall 436 of FIGS. 1 to 27) spaced apart from the first wall (e.g., the first wall 435 of FIGS. 1 to 27).

According to an embodiment of the present disclosure, the coupling member (e.g., the coupling member 430 of FIGS. 1 to 27) may include a connecting portion (e.g., the connecting portion 434 of FIGS. 1 to 27) connecting the first wall (e.g., the first wall 435 of FIGS. 1 to 27) and the second wall (e.g., the second wall 436 of FIGS. 1 to 27).

According to an embodiment of the present disclosure, the coupling member (e.g., the coupling member 430 of FIGS. 1 to 27) may include a protrusion (e.g., the protrusion 437 of FIGS. 1 to 27) protruding from the second wall (e.g., the second wall 436 of FIGS. 1 to 27) radially outward the port (e.g., the port 420 of FIGS. 1 to 27).

According to an embodiment of the present disclosure, the wearable electronic device (e.g., the electronic device 101 of FIGS. 1 to 27) may include a spring (e.g., the spring 440 of FIGS. 1 to 27) movably disposed inside the port (e.g., the port 420 of FIGS. 1 to 27) with the coupling member (e.g., the coupling member 430 of FIGS. 1 to 27).

According to an embodiment of the present disclosure, the spring (e.g., the spring 440 of FIGS. 1 to 27) may include a plurality of springs (e.g., the springs 440 of FIGS. 1 to 27) disposed to correspond to the plurality of coupling members (e.g., the coupling member 430 of FIGS. 1 to 27), respectively.

According to an embodiment of the present disclosure, the spring (e.g., the spring 440 of FIGS. 1 to 27) may include a first spring portion (e.g., the (1-1)^{th} spring portion 4411, the (2-1)^{th} spring portion 4421, and the (3-1)^{th} spring portion 4431 of FIGS. 1 to 27) extending along the circumferential direction of the port (e.g., the port 420 of FIGS. 1 to 27).

According to an embodiment of the present disclosure, the spring (e.g., the spring 440 of FIGS. 1 to 27) may include a second spring portion (e.g., the (1-2)^{th} spring portion 4412, the (2-2)^{th} spring portion 4422, and the (3-2)^{th} spring portion 4432 of FIGS. 1 to 27) spaced apart from the first spring portion (e.g., the (1-1)^{th} spring portion 4411, the (2-1)^{th} spring portion 4421, and the (3-1)^{th} spring portion 4431 of FIGS. 1 to 27) and supported by the coupling member (e.g., the coupling member 430 of FIGS. 1 to 27).

According to an embodiment of the present disclosure, the spring (e.g., the spring 440 of FIGS. 1 to 27) may include a bending portion (e.g., the first bending portion 4413, the second bending portion 4423, or the third bending portion 4433 of FIGS. 1 to 27) connecting the first spring portion (e.g., the (1-1)^{th} spring portion 4411, the (2-1)^{th} spring portion 4421, and the (3-1)^{th} spring portion 4431 of FIGS. 1 to 27) and the second spring portion (e.g., the (1-2)^{th} spring portion 4412, the (2-2)^{th} spring portion 4422, and the (3-2)^{th} spring portion 4432 of FIGS. 1 to 27).

According to an embodiment of the present disclosure, the second spring portion (e.g., the (1-2)^{th} spring portion 4412, the (2-2)^{th} spring portion 4422, and the (3-2)^{th} spring portion 4432 of FIGS. 1 to 27) may pass through a space between the first wall (e.g., the first wall 435 of FIGS. 1 to 27) and the second wall (e.g., the second wall 436 of FIGS. 1 to 27).

According to an embodiment of the present disclosure, the coupling member (e.g., the coupling member 430 of FIGS. 1 to 27) may include a first coupling member (e.g., the first coupling member 431 of FIGS. 1 to 27) and a second coupling member (e.g., the second coupling member 432 of FIGS. 1 to 27) that are spaced apart from each other along a circumferential direction of the port (e.g., the port 420 of FIGS. 1 to 27).

According to an embodiment of the present disclosure, the bending portion (e.g., the first bending portion 4413, the second bending portion 4423, or the third bending portion 4433 of FIGS. 1 to 27) may be located between the first coupling member (e.g., the first coupling member 431 of FIGS. 1 to 27) and the second coupling member (e.g., the second coupling member 432 of FIGS. 1 to 27).

According to an embodiment of the present disclosure, the number of the plurality of recesses (e.g., the recesses 4822 of FIGS. 1 to 27) may be greater than two.

According to an embodiment of the present disclosure, the coupling member (e.g., the coupling member 430 of FIGS. 1 to 27) may include a plurality coupling members spaced apart from each other along the circumferential direction of the port (e.g., the port 420 of FIGS. 1 to 27).

According to an embodiment of the present disclosure, the number of the plurality of coupling members (e.g., the coupling members 430 of FIGS. 1 to 27) may be greater than two.

According to an embodiment of the present disclosure, the spring (e.g., the spring 440 of FIGS. 1 to 27) is configured to provide a restoring force to the coupling member (e.g., the coupling member 430 of FIGS. 1 to 27). toward the eartip (e.g., the eartip 480 of FIGS. 1 to 27)

According to an embodiment of the present disclosure, the wearable electronic device (e.g., the electronic device 101 of FIGS. 1 to 27) may include a plurality of coupling members (e.g., the coupling members 430 of FIGS. 1 to 27) connecting the eartip (e.g., the eartip 480 of FIGS. 1 to 27) and the port (e.g., the port 420 of FIGS. 1 to 27) and spaced apart from each other along the circumferential direction of the port (e.g., the port 420 of FIGS. 1 to 27).

According to an embodiment of the present disclosure, the eartip (e.g., the eartip 480 of FIGS. 1 to 27) may include a recess (e.g., the recess 4822 of FIGS. 1 to 27) into which at least a portion of the plurality of coupling members (e.g., the coupling member 430 of FIGS. 1 to 27) is inserted.

According to an embodiment of the present disclosure, the recess (e.g., the recesses 4822 of FIGS. 1 to 27) may be provided in plural to correspond to the plurality of coupling members (e.g., the coupling member 430 of FIGS. 1 to 27), respectively.

According to an embodiment of the present disclosure, the wearable electronic device (e.g., the electronic device 101 of FIGS. 1 to 27) may include a recess (e.g., the recess 4822 of FIGS. 1 to 27) into which at least a portion of the coupling member (e.g., the coupling member 430 of FIGS. 1 to 27) is inserted.

According to an embodiment of the present disclosure, the recess (e.g., the recesses 4822 of FIGS. 1 to 27) may include a plurality of recesses spaced apart from each other along the circumferential direction of the eartip (e.g., the eartip 480 of FIGS. 1 to 27).

According to an embodiment of the present disclosure, the recess (e.g., the recesses 4822 of FIGS. 1 to 27) may extend curved along the circumferential direction of the eartip (e.g., the eartip 480 of FIGS. 1 to 27).

According to an embodiment of the present disclosure, at least a portion of the coupling member (e.g., the coupling member 430 of FIGS. 1 to 27) may be movably inserted into the recess (e.g., the opening 4830 of FIGS. 1 to 27).

According to an embodiment of the present disclosure, the wearable electronic device (e.g., the electronic device 101 of FIGS. 1 to 27) may include a plurality of springs (e.g., the springs 440 of FIGS. 1 to 27) disposed to correspond respectively to the plurality of coupling members (e.g., the coupling member 430 of FIGS. 1 to 27) and to move together with the plurality of coupling members (e.g., the coupling member 430 of FIGS. 1 to 27), and spaced apart from each other along the circumferential direction of the port (e.g., the port 420 of FIGS. 1 to 27).

According to an embodiment of the present disclosure, the wearable electronic device (e.g., the electronic device 101 of FIGS. 1 to 27) may include a coupling member (e.g., the coupling member 430 of FIGS. 1 to 27) connecting the eartip (e.g., the eartip 480 of FIGS. 1 to 27) and the port (e.g., the port 420 of FIGS. 1 to 27).

According to an embodiment of the present disclosure, the wearable electronic device (e.g., the electronic device 101 of FIGS. 1 to 27) may include a mesh member (e.g., the mesh member 424 of FIGS. 1 to 27) coupled to the eartip (e.g., the eartip 480 of FIGS. 1 to 27) and located adjacent to the opening (e.g., the opening 483 of FIGS. 1 to 27) closer than the coupling member (e.g., the coupling member 430 of FIGS. 1 to 27).

Non-limiting example embodiments of the present disclosure have been described above with reference to the accompanying drawings. However, it will be evident to a person ordinarily skilled in the art that various modifications in form and detail can be made without departing from the spirit and scope of the present disclosure.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A wearable electronic device comprising:
a housing including a space;
a port that at least partially protrudes outward from the housing;
an eartip comprising an opening, the eartip connected to the port;
a speaker inside the housing and configured to output sound toward the opening of the eartip; and
at least one coupling member connecting the eartip and the port,
wherein the eartip includes at least one recess into which at least a portion of the at least one coupling member is inserted.

2. The wearable electronic device of claim 1, wherein the at least one coupling member comprises a plurality of coupling members that are spaced apart from each other along a circumferential direction of the eartip, and
wherein the at least one recess includes a plurality of recesses that are spaced apart from each other along the circumferential direction of the eartip.

3. The wearable electronic device of claim 2, wherein the plurality of coupling members are at least partially inserted into the plurality of recesses, respectively.

4. The wearable electronic device of claim 2, wherein the plurality of recesses are spaced apart from each other along a circumferential direction of the port.

5. The wearable electronic device of claim 2, wherein the port comprises a port wall configured to accommodate at least a portion of the at least one coupling member, and
wherein the at least one coupling member comprises at least one protrusion configured to penetrate the port wall and be inserted into at least one of the plurality of recesses.

6. The wearable electronic device of claim 2, wherein the eartip comprises a holding portion that at least partially surrounds the port, and
wherein the holding portion includes the plurality of recesses.

7. The wearable electronic device of claim 2, wherein the at least one coupling member comprises:
a first wall;
a second wall spaced apart from the first wall;
a connecting portion connecting the first wall and the second wall; and
a protrusion protruding from the second wall in a direction radially outwardly of the port.

8. The wearable electronic device of claim 2, further comprising:
at least one spring inside the port, the at least one spring configured to move with the at least one coupling member.

9. The wearable electronic device of claim 8, wherein the plurality of coupling members are at least partially inserted into the plurality of recesses, respectively, and
wherein the at least one spring comprises a plurality of springs that are adjacent to the plurality of coupling members, respectively.

10. The wearable electronic device of claim 8, wherein the at least one spring comprises:
a first spring portion extending along a circumferential direction of the port;
a second spring portion spaced apart from the first spring portion and supported by the at least one coupling member; and
a bending portion connecting the first spring portion and the second spring portion.

11. The wearable electronic device of claim 10, wherein the at least one coupling member comprises:
a first wall;
a second wall spaced apart from the first wall; and
a connecting portion connecting the first wall and the second wall, and
wherein the second spring portion passes through a space between the first wall and the second wall.

12. The wearable electronic device of claim 10, wherein the at least one coupling member comprises a first coupling member and a second coupling member that are spaced apart from each other along the circumferential direction of the port, and
wherein the bending portion is between the first coupling member and the second coupling member.

13. The wearable electronic device of claim 2, wherein the plurality of recesses comprises at least three recesses.

14. The wearable electronic device of claim 1, wherein the at least one recess extends curved along a circumferential direction of the eartip, and wherein at least a portion of the at least one coupling member is movably inserted into the at least one recess.

15. The wearable electronic device of claim 1, further comprising:
at least one spring movably disposed inside the port together with the at least one coupling member,
wherein the at least one spring is configured to provide a restoring force to the at least one coupling member toward the eartip.

16. A wearable electronic device comprises:
a housing including a space formed;
a port protruding at least partially outward from the housing;
an eartip connected to the port and including an opening;
a speaker inside the housing and configured to output sound toward the opening of the eartip;
a plurality of coupling members connecting the eartip and the port, the plurality of coupling members being spaced apart from each other along a circumferential direction of the port; and
a plurality of springs that are configured to move together with the plurality of coupling members, respectively, the plurality of springs being spaced apart from each other along the circumferential direction of the port.

17. The wearable electronic device of claim 16, wherein the eartip comprises a plurality of recesses, and
wherein the plurality of coupling members are at least partially inserted into the plurality of recesses, respectively.

18. The wearable electronic device of claim 17, wherein the plurality of recesses are spaced apart from each other along the circumferential direction of the port.

19. The wearable electronic device of claim 17, wherein the port comprises a port wall configured to accommodate at least a portion of the plurality of coupling members, and
wherein the plurality of coupling members comprises at least one protrusion configured to penetrate the port wall and be inserted into at least one of the plurality of recesses.

20. A wearable electronic device comprising:
a housing including a space;
a port protruding at least partially outward from the housing;
an eartip connected to the port and including an opening;
a speaker inside the housing and configured to output sound toward the opening of the eartip;
a coupling member connecting the eartip and the port; and
a mesh member connected to the eartip, the mesh member being closer than the coupling member to the opening.
